(19) United States
(12) Patent Application Publication
(10) Pub. No.: US 2011/0066510 A1
(43) Pub. Date: Mar. 17, 2011

(54) Methods for valuing and placing advertising

(76) Inventor: Galip Talegon, Novato, CA (US)

(21) Appl. No.: 12/923,263

(22) Filed: Sep. 10, 2010

Related U.S. Application Data
(63) Continuation-in-part of application No. 10/345,026, filed on Jan. 14, 2003.
(60) Provisional application No. 60/349,110, filed on Jan. 16, 2002.

(51) Int. Cl. G06Q 30/00

(52) U.S. Cl. 705/14.71

(57) ABSTRACT

Advertising segments are valued and placed on a platform based on competitive bidding. Publishers having available advertising space allow access to the space via an intermediary. The intermediary accepts bids from potential advertisers, ranks the bids and awards allocated segments to the bidders according to the rankings. Payments for the placement of advertising may be made on a per-display basis, on a per click-through or on a per transaction basis. Advertisers will have some level of access to the advertising space. The higher the bid amount, then the higher percentage of access is given to the advertising space for an advertiser's advertisements.

### CROSS-REFERENCE TO RELATED APPLICATIONS

This application is a Continuation-In-Part of U.S. patent application Ser. No. 10/345,026, filed on Jan. 14, 2003, which claims the benefit of U.S. Provisional Patent Application No. 60/349,110, filed on Jan. 16, 2002.

### FIELD OF THE INVENTION

The present invention relates to the placement and valuation of advertisements in an advertising space. More particularly, the present invention relates to methods through which the value of a specific advertising platform can be determined, appropriate costs are established for placing different quantities of advertising on the space on the platform, and access to the advertising space is provided based upon competitive bidding.

### DISCUSSION OF THE RELATED ART

There are many forms of traditional advertising including print media (newspapers, magazines and other periodicals or publications), billboards and broadcast media (television, radio and the like). The advent of technology has broadened available avenues for advertising which can now be provided on such media as large screens (jumbotron) or changeable lighted displays deployed in sporting arenas or along highways, changeable rotatable banners such as those set up along the sidelines of sporting arenas, screen overlays in television broadcasts, cellular telephones or watches having text and video capabilities, hand held computers and the like.

The ever-increasing popularity of the internet makes it a highly desirable place for advertisers to market their products and services. Such marketing can be observed by the advertising banners that are associated with widely used internet web sites. These banners are displayed as part of the accessed web pages, usually in or around the borders of the pages. In addition, pop-up advertising banners have also recently come into use. Pop-up banners are windows that display advertising over and prevent the user from seeing the underlying web page until the pop-up banner window is either accessed or closed.

The cost and content of standard or pop-up advertising banners has been controlled by the owner or publisher of the web page or web site. Such publishers establish the cost of placing advertising in these banners which in many cases is prohibitively expensive for otherwise interested advertisers. As a result, only those advertisers with the largest budgets have any chance at receiving advertising space on web banners. In many cases, such advertisers may be required to purchase more advertising space than they need. As a result, advertising space is wasted, smaller advertisers are left out and the publishers lose potential revenue.

At least one company markets internet keywords, not advertising, on a paid basis. Under this system, a higher payment by a participant will result in that participant appearing higher on a list generated by an internet search using the keyword. This scheme, however, has nothing to do with advertising, advertising banners or their content that appear on most major web sites.

Every advertiser is unique, having unique products and/or services to be marketed. Similarly, every advertising media and web site is also unique, with different media and web sites appealing to the different interests of different people. As a result, the advertising opportunity available on each publisher's space is also unique to each advertiser, depending upon the potential connection between the products and/or services to be marketed, and the potential visitors to the publisher's space or web site. For example, guns are advertised in hunting magazines and fabrics advertised in sewing magazines.

Because each publisher's space has a different value to different advertisers, it is not possible to satisfy all advertisers by offering one set of, or a flat, advertising rate. Flat-rates for advertising space have resulted in fewer and fewer different advertisers placing their advertising on publishers' web sites or available media. When the incremental cost of an advertising agency is added to the advertising rate, the resulting expense can be prohibitively high.

Many small and medium-sized advertisers only desire to reach a certain minimal level of exposure through advertising, and would be better served by limited but broad access to a publisher's media platform. A significant problem faced by large companies or portals is selling their ad space on their company web sites. They receive millions of visitors each month to their web sites, however, they are not able to sell advertising on these pages that are viewed by millions because they have a set rate for their advertising.

Most advertisers or small business owners with web sites cannot afford to buy advertising at that rate, and the ones that can afford it choose not to since the return on investment is not attractive. As a result, these large companies and portals lose significant potential advertising revenue that might otherwise be generated.

### SUMMARY OF THE INVENTION

It is therefore desirable to provide a method by which an advertiser of any size may have access to a publisher's media platform commensurate with the exposure sought by the advertiser. Such a method would give advertisers the freedom to determine how much should be spent for a specific advertisement on a specific publisher's space.

Publishers may maximize the use of their advertising space by making such space available at different rates to advertisers. It also is desirable for advertisers to be able to directly place advertising without having to hire an advertising agency. This feature would allow the advertiser to choose the publishers he wants to advertise on and also determine how much he is willing to pay for their advertising space. It also is desirable to establish variable rates for different levels of advertising based upon the demand for the publisher's specific advertising space, thereby giving the advertiser freedom and flexibility to determine how much advertising can be afforded on the publisher's space, with the advertiser knowing that the higher rate he pays, the more displays his advertising will receive on the publisher's space.

The present invention addresses the above-described desires by providing methods whereby publishers having advertising space make that space available to potential advertisers, and advertisers gain access to the advertising space through competitive bidding. Under these methods, publishers are able to sell display on their platform at different prices on a competitive bidding basis, the prices being determined by such things as quality (a particular time slot), quantity (i.e., number of displays), viewer response, etc. This gives a level of access to every potential advertiser who can purchase as much or as little access to a specific publisher's advertising space as desired, according to competitive bidding.

The advertiser chooses the publishers he wants to advertise on and also determines how much he is willing to pay for their advertising space. This will result in a benefit to publishers through an increase in the overall use of their available advertising space, and will result in a benefit to advertisers by providing at least some level of access to such advertising space by any potential advertiser.

In its most basic aspect, the methods of the present invention are available for any advertising space that can be divided into displays rotated during a period of time. Thus, the disclosed embodiments may use a segment to refer to an amount of displays allocated to an advertiser for the advertising space. The segments allocated are for a single advertising space, but multiple advertisers receive access to the space based on their bids. The advertising space can be such an easily changed advertising space as a banner on a web page, a changeable display on a jumbotron screen, a changeable overlay on a video broadcast, a changeable banner at sports arenas, a display on cellular telephones, wireless internet, a video display on hand held computer devices, and the like.

Alternatively, an advertising space as contemplated by the present invention may also include such things as television and radio spots or time slots, or regionally different versions of printed publications. Examples of an allocation to an advertising space would include without limitation a certain number of banner displays on a web site, a certain number of seconds that a television overlay is displayed during a sporting event, a single radio or TV commercial spot in a given time slot, the distribution of a printed publication into a certain geographic region, etc. It is to be appreciated that the methods of the present invention may be used for any technology having available advertising space.

According to the disclosed embodiments, the advertising spaces of numerous different publishers are made available to an intermediary. The intermediary organizes and categorizes the advertising spaces, and makes them available to potential advertisers. This is preferably done on a web site, although any appropriate platform may be used. Through the intermediary, the potential advertiser is able to determine what his advertising dollar will purchase in terms of access to the available advertising spaces. For example, a small number of banner displays (e.g., displays of the advertiser's material per “n” hits on the web page) may be available on a popular web page for the same price as a large number of banners on a less popular web page.

Alternatively, smaller banners may be less expensive than larger ones, and less popular time slots may be less expensive than prime-time slots. The potential advertiser is able to review the available advertising space, and make decisions regarding which allocations to the advertising space they desire to purchase. Then, the advertiser places a bid for the advertising space. The bidding and response process is an interactive one, and can be accomplished using any appropriate interactive method such as without limitation a web site, email, and telephone, facsimile or in-person.

In one aspect of the invention, such a bid may be accepted or rejected depending upon whether and how many other advertisers is also bidding for the same advertising space. A rejection would indicate that the advertiser has failed to meet the minimum bid required for the advertising space. If rejected, the advertiser will be informed as to the cost for an advertising space and given the opportunity to bid again.

In another aspect of the invention, the advertiser will be informed that the bid submitted will not purchase access to the advertising space, but could be used to purchase less expensive alternative advertising space (e.g. a different sized banner, a banner on a different web page, a banner display at a less popular time, etc.). In this way, an advertiser may be able to afford a bid on less-used advertising space of the publisher, resulting in a win-win with the publisher receiving otherwise lost revenue, and the advertiser being able to place at least some advertising with the publisher.

Once a bid is accepted, the advertising is submitted for review by the publisher so as to avoid republication of scandalous, false or otherwise inappropriate content. Following approval, the advertising is placed on the desired advertising space according to the segments allocated for display. The advertising bidder's account with the intermediary is debited either before or after the advertising is placed, depending upon the requirements of the publisher and the payment method selected. Additional or alternative allocations may be bid on and purchased in the same manner.

Through these methods, the advertiser determines how much he will spend to place advertising on the publisher's space knowing that the higher rate paid, the more displays or segments his advertising will receive on the publisher's advertising space. Through competitive bidding, advertisers have the freedom and flexibility to determine how much they are willing to pay for access to a specific publisher's advertising space. These methods also help both publishers and advertisers by allowing advertisers learn the cost of advertising on a publisher's web site or publisher's ad space. The methods of the present invention can be applied to large businesses, medium size businesses or small businesses.

Internet and related applications will benefit particularly from these methods since the web site owner can use these methods without having to hire an advertising agency. In interne applications, advertising spaces may be in the form of the banners that are displayed with a web page when accessed by a user. The content of these banners may be changed such that different content may be displayed each time the web page is accessed. In different aspects of the invention, the advertiser may bid for this space based on: (1) the number of times his advertising is simply displayed to users on the web page (e.g., CPM=cost per 1000 such displays); or (2) whether or not the user clicks through to the advertising, taking the user to the advertiser's own web site; or (3) whether or not the user enters into a transaction based on access through the advertising.

Each of these pricing scenarios would have a different cost, lower costs being associated with simply displaying the advertising, and higher costs being associated with actual transactions generated by the advertising. In a CPM situation, the advertiser pays for the display on the publisher's platform regardless of whether the web site visitor clicks on the advertising. On the other hand, with pay per click-through, the advertiser only pays when the visitor clicks on the banner ad and goes to where the banner directs him. The advertiser does not pay for impressions with this method, but pays when a click through occurs landing the visitor to another site through the banner advertisement. With payment per action or transaction, the advertiser only pays when a transaction or action occurs as a result of that specific click through (e.g., a purchase was made by filling out a form, a survey was filled out, or a ballot was conducted, etc.).

With these methods, no matter how small or large the advertiser's budget, the advertiser is able to advertise at some level on any given publisher's space. The methods allow all advertisers to advertise within their budget. The value of an advertising space on a publisher's web site is different for each unique advertiser, and using these methods the advertiser is able to evaluate a specific publisher's advertising cost based on what the advertiser thinks it should cost.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a block diagram of a system for valuing and placing advertisements according to the disclosed embodiments.

FIG. 2 illustrates a flowchart for a publisher to access an intermediary to make advertising space available according to the disclosed embodiments.

FIG. 3 illustrates a flowchart for an advertiser to register for access to advertising space according to the disclosed embodiments.

FIG. 4 illustrates a flowchart for accepting bids and allocating access to an advertising space according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

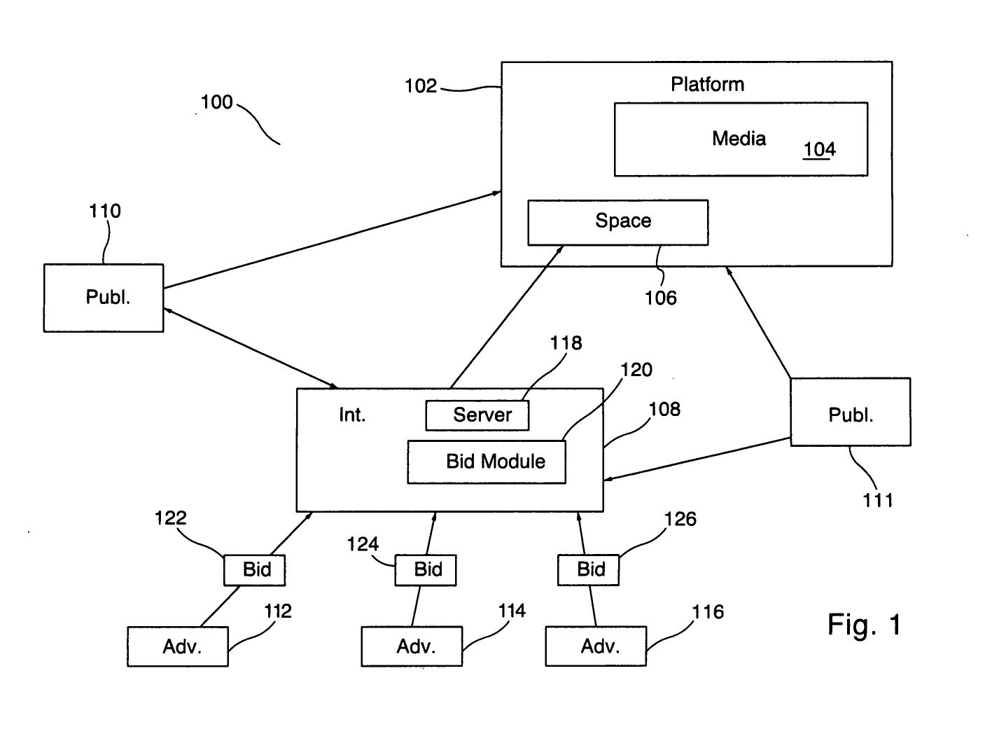

FIG. 1 depicts a system 100 for valuing and placing advertisements according to the disclosed embodiments. A platform 102 includes media 104 and space 106. Platform 102 may be known as a media platform and supports these features as the media 104 and advertising space 106 are displayed to potential consumers. Platform 102, therefore, may be a sign, a web page, a screen for viewing programs and the like. Media 104 may be a film, picture, graphics on a web page, and the like that serves to interest the consumer. Advertising space 106 includes a portion of platform 102 that displays advertisements. Alternatively, platform 102 only may include space 106 such that no media 104 is displayed.

For example, if platform 102 is a sign, then media 104 may be a picture while advertising space 106 includes a space to display an advertisement in accordance with the disclosed embodiments. If platform 102 is a web page, then space 106 may be a banner displayed to a user. Access to advertising space 106 may be allocated in a segment assigned to an advertiser. As disclosed above, a segment, or allocation, may refer to the amount of displays for the advertisement on advertising space 106 on a rotational basis.

System 100 also includes intermediary 108, publishers 110 and 111, and advertisers 112, 114 and 116. Intermediary 108 establishes relationships with publishers 110 and 111 and with advertisers 112, 114 and 116 to allocate advertisements to space 106, as disclosed below. According to the disclosed embodiments, every advertiser will have opportunities to place their advertisements on space 106, as opposed to only one advertiser having their advertisements displayed. Additional publishers and advertisers may interact with intermediary 108 for a variety of platforms, and the number of entities within system 100 is not limited by the ones shown in the present application.

Intermediary 108 includes server 118 to store advertisements and information provided by publishers 110 and 111 and advertisers 112, 114 and 116. For example, advertisements may be uploaded from advertiser 114 to server 118 for display in space 106. Intermediary 108 also includes bidding module 120 that receives bids from advertisers and then executes a process to allocate advertisements at specified times depending on the bids. Thus, advertiser 112 submits bid 122, advertiser 114 submits bid 124 and advertiser 116 submits bid 126. These bids provide the data used by bidding module 120 and intermediary 108 to allocate advertisements to space 106.

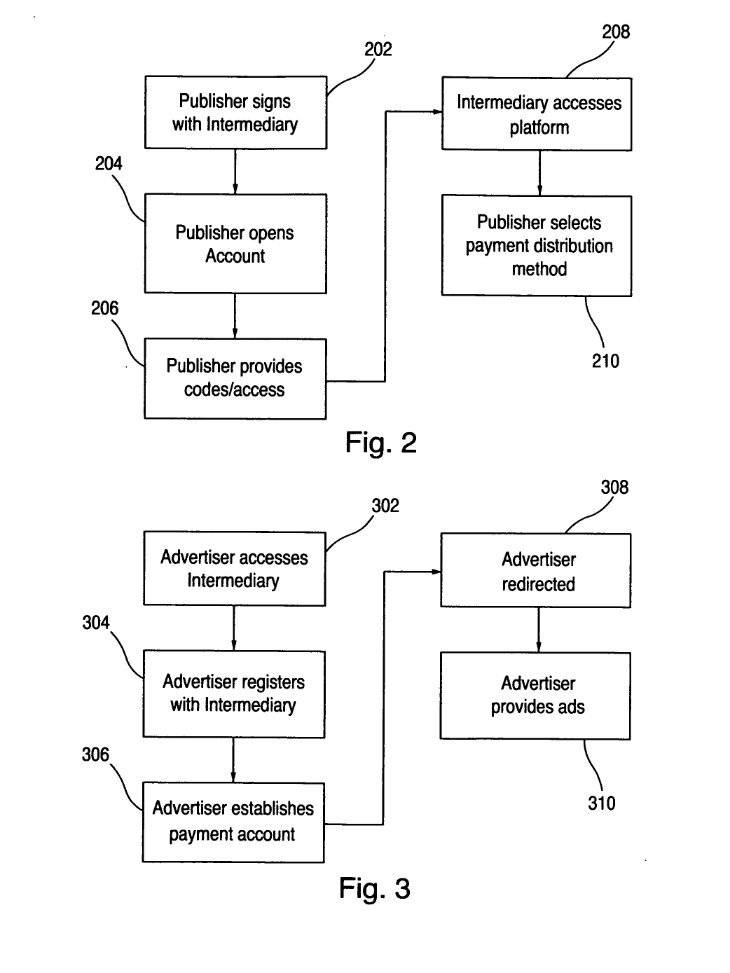

FIG. 2 depicts a flowchart for a publisher to access an intermediary to make advertising space available to according to the disclosed embodiments. Step 202 executes publisher 110, (in this example, a large company or portal with ten million or more visitors to their web sites) signing up with the intermediary 108 for the placement of advertising on its platform 102 having space 106. Publisher 110 contacts intermediary 108, preferably through the intermediary's web site, and finds the industry/sector from a list of categories that most closely match the publisher's company.

Step 204 executes by publisher 110 opening an account with intermediary 108. The publisher 110 provides the intermediary 108 with important information such as web traffic analysis, statistics of the publisher, web pages where the publisher 110 wants to sell advertising, etc. Publisher 110 also may provide payment information to intermediary 108.

Step 206 executes by publisher 110 providing information, such as codes or other access data, to allow intermediary 108 to have access to platform 102. Using the web page example, the publisher 110 is directed to one of the intermediary's web pages where the publisher 110 is asked to copy and paste a special code into the html section of the publisher's web pages containing the ad space for space 106 where the banner ads are to be placed. Step 208 executes by intermediary 208 accessing platform 102. The code allows the intermediary 208 to access and display advertising on space 106 from the intermediary's own server, such as server 118. The publisher 110 has the option of placing the code at that moment, or placing it later since it may be provided via e-mail.

Step 210 executes by having the publisher 110 selecting one of the payment distribution methods to receive its portion of the payments made by advertisers. Because the intermediary 108 sells the advertising space 106 on behalf of the publisher 110 and charges the advertisers 112, 114 and 116 directly. The intermediary 108 collects the funds from the advertisers 112-116, and then transfers or distributes an agreed amount to the publisher 110 according to whatever payment method is selected. Accordingly, the publisher 110 picks a method of accrual (such as pre-pay, or pay per click-through), and a method of payment by the intermediary (such as direct deposit to his account or check by mail, etc.). The publisher 110 may establish a minimum acceptable bid amount for access to each advertising space 106.

If the publisher 110 chooses not to set a minimum acceptable bid, the minimum bid will be defaulted to some small amount such as one cent ($0.01) or one dollar ($1.00). In this case, a bid that is equal to or higher than the minimum will have his advertising displayed on the publisher's platform as long as the advertiser 108 obeys the regulations and terms set by the intermediary 110 and agreed upon by the publisher 110.

FIG. 3 depicts a flowchart for an advertiser to register for access to advertising space according to the disclosed embodiments. Step 302 executes by an advertiser, such as advertiser 114, accessing a web site for intermediary 108. Advertiser 114 also may access electronic records provided by intermediary 108, such as stored in a computer-readable medium. When potential advertisers come to the intermediary 108, they are able to explore the applicable web site and see models and demonstrations. Advertiser 114 can select from different categories and learn which publishers are selling advertising space on via the intermediary 108.

If the advertiser 114 sees a publisher, such as publisher 110, whose advertising space 106 they desire to access, step 304 executes by having the advertiser 114 register with the intermediary 108 in order to bid on the space 106. This step includes providing basic information about the advertiser (names, phone numbers, mailing address, email address, etc.). Step 306 executes by advertiser 114 establishing an account through which payment for advertising will be accomplished. This may be a credit line, deposit account, or other satisfactory payment vehicle. Funds will be taken from the account to cover the expenses incurred by advertiser 114 in placing advertisements with different publishers.

Step 308 executes by the advertiser 114 being redirected to another web page. Step 310 executes by the advertiser 114 being instructed regarding uploading of his banners or advertisement materials onto the server 118 of the intermediary 108. The advertiser 114 can later add, edit, and assign advertisements to be used for different ad campaigns. At this point, the advertiser 114 is ready to place a bid 124 to advertise on any publisher's advertising space 106 that is listed with the intermediary 108.

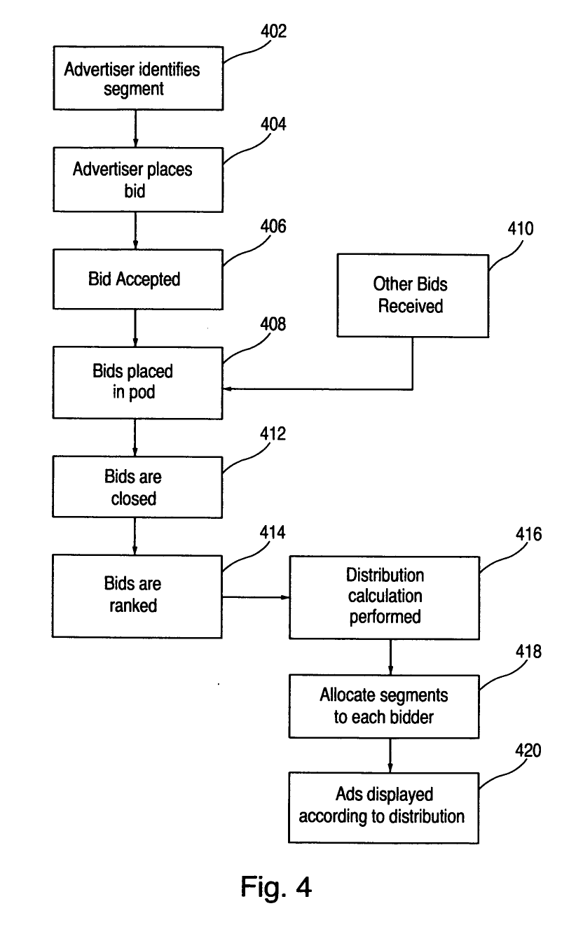

FIG. 4 depicts a flowchart for accepting bids and allocating access to advertising space according to the disclosed embodiments. In this example, which uses payment per CPM, step 402 executes by the advertiser, such as advertiser 112, identifying the specific advertising space 106 of a publisher 110 or 111 that the advertiser 112 desires to place advertising.

Step 404 executes with the advertiser 112 placing an amount, referred to as a “bid,” that represents what the advertiser 112 thinks the specific publisher's advertising space 106 should cost, and may be shown by bid 122 in FIG. 1. Every advertiser seeking to place advertising on the publisher's space has the flexibility and the freedom to determine the amount for which they pay per CPM (cost per 1000 impressions).

The higher the amount of bid 122, the more often the advertisement for advertiser 112 will be displayed on a banner ad rotation on platform 102. The advertiser 112 submits bid 122. Step 406 executes with bid 122 being accepted by intermediary 108. Preferably, bid 122 is received by bidding module 120.

Step 408 executes by placing bid 122 into a pool along with the bids of other advertisers. Step 410 executes by receiving other bids from other advertisers, such as bids 124 and 126 from advertisers 114 and 116. Step 412 executes by closing the bids for space 106 on platform 102 via intermediary 108.

When the bids are closed, step 414 executes by ranking the received bids from advertisers. Step 416 executes by having a distribution calculation performed to determine how many advertisement displays should be allocated to each bidder, according to rank. The distribution calculation may include an algorithm to weigh bids according to amounts, determine a ranking or factor and then allocates time slots or segments, according to the ranking or factor assigned to the advertisers.

Step 418 executes by allocating a segment to each advertiser that placed bids. The segment is an allocation of displays based on the received bid for the advertising space. Because this is a CPM example, all bidder accounts are charged as soon as the bidding is closed, and the publisher is paid according to its agreement with the intermediary.

Step 420 executes by having advertisements displayed according to the distribution. As noted above, each advertiser is allocated a segment for an amount of displays on the advertising space. Over a time period, the segments rotate with advertisements on space 106. As segments change, the advertisements on advertising space 106 may change according to the allocations calculated according to the percentages determined by the present invention.

By way of example, if ABC Company is the publisher, X Company and Y Company are the advertisers that wish to advertise on ABC Company's web site banners. X Company has a larger advertising budget than Y Company, so X Company places a bid of $11.85 per CPM to advertise on ABC Company's web site. Y Company places a bid of $0.65 per CPM to advertise on the same space on ABC Company's web site. If there are total of 149 advertisers participating in this campaign upon reaching the deadline for placing bids for this particular space, it turns out that X Company is ranked #1 and Y Company is ranked #149. The intermediary 108 will calculate number of segments for each advertiser's banner ad displays on the publisher's web site based on their rank, each of which will be different.

X Company, having placed the highest bid is ranked #1, and will receive the highest number of banner ads being displayed on the publisher's advertising space, such as every fourth hit. Meanwhile, Y Company having placed the lowest bid and receiving the lowest ranking, will receive the lowest allocation, such as every 18,000^{th} hit.

Because the banners are displayed on the publisher's site through a rotating banner mechanism, the intermediary determines whose banner should be displayed on the rotation according to calculations made based on the dollar amounts of the bids and the rankings (from the highest bid to the lowest bid). The one with the highest bid is the highest ranked advertiser (ranked #1), and will receive more allocations than the others. Advertisers that come after him on the ranking will receive fewer allocations, as the lowest ranked advertiser will have the lowest allocation. Thus, the bidding sets the ranking of the advertisers which relates to the allocation of advertising displays, or segments. It is not a real auction (winner take all) since every bidder with a minimum bid gets to advertise.

If the advertising campaign lasts one month, within that month, from among all the participating advertisers, the highest ranked advertiser will have his banner ad shown on the publisher's web site more times than any of the other participants. Depending upon the number of hits that occur during the month, it is possible that some of the participating advertisers will not have any of their paid banner ads displayed on the publisher's web site within that period simply because they have a lower number of displays and are ranked lower. In this situation, these lower ranked advertisers' paid banner ads may simply be forfeited, or they may be automatically transferred to the ad campaign for the next period, to be displayed on that same publisher's web site.

Because there is a new advertising period, advertisers have the chance to increase their bids relative to the new period to try to increase their number of displays. Many of the original advertisers are also likely to participate again, and potentially new advertisers may also participate, so it is not possible for the advertiser to know what change in ranking, if any, may be achieved by increasing his bid.

In highly competitive situations, an increased bid may result in simply staying at the same rank, or may actually result in a loss in rank (which loss would have been greater were the bid not increased). It is also possible for all advertisers to place new bids, make changes to their bids, or edit their banners. When this time expires, all placed bids are locked and the ranking is again determined. A segment is calculated for each participant, the advertiser accounts are charged, and the ad campaign starts again.

Other embodiments of the invention are more suitable for use with medium or small sized companies whose web pages are not as popular or well known. The present invention may be applied in three different ways for medium and small sized publishers which can offer advertising through the intermediary on a pay per CPM, pay per click-through, or pay per transaction basis. The publisher selects the single payment method that best fits its situation, the three payment methods being mutually exclusive or available as a combination of payment options.

If the publisher is large or well known, the CPM method described previously may be the most profitable. However, if the publisher is not well known, it may not be able to obtain very high CPM rates, and may be more interested in offering its advertising space on a click-through or pay per transaction basis. This is appealing to the advertiser because it only has to pay if there is a click-through or a transaction.

If pay per transaction is made available by the publisher and is selected by the advertiser, it is also of significant secondary value to advertisers. Using pay per transaction, the invention offers the advertisers a large sales force solution that is essentially free of cost. The advertisers only pay a commission after a sale is conducted (transaction) without a sales team to do the selling for them. With pay per transaction, the publisher only receives payment for advertising when a visitor is redirected to the advertiser's web site and that same visitor actually initiates a transaction (e.g. the purchase of goods or services, sending an e-mail, filling out a survey, etc.).

In such a case, the advertiser's bid results in actual sales, and not just marketing. This whole concept creates a valuable sales force to the advertiser. He does not have to pay for anything until a transaction (sale of goods or services) takes place. Such charges may be billed each time a transaction occurs or at the end of the advertising period.

For any of the payment methods, the publisher relinquishes its advertising space to be divided up among the bidders. However, in the pay per click-through or pay per transaction options, the number of segments allocated to each advertiser is directly proportional to the relationship of their bid amount to the total of all bids. This translates into the number of segments or displays that will be made using the advertiser's material.

If the ad space is available on a pay transaction basis, and there are five advertisers, each bidding $10.00 per transaction, there will be a 5-banner rotation with each advertiser receiving equal display allocations (one out of every five). If four of the advertisers bid $10.00 and the fifth bids $20.00, then there will be a six-segment rotation, with the fifth bidder receiving two out of every six segments, and the others receiving only one out of every six segments.

Alternatively, the disclosed embodiments may not permit bids of equal value. Thus, if an advertiser places a bid amount that is already in the pool, then the advertiser may be notified that another bid must be placed above or below the rejected amount. The non-equal bids allows for rankings of the bids such that the allocation of displays is not equal. For example, if a bid of $10.00 per transaction already in the pool, then the advertiser may bid $9.00 or $11.00 to have their bid accepted.

Thus, the bid amount determines the proportional number of displays on the advertising space using the advertiser's material. Only if there is a transaction is the advertiser charged his bid amount. This same example also applies to the click-through option, with the bid amount determining the number of displays, and an actual click-through resulting in a charge to the advertiser.

An added benefit to advertisers is also provided by the methods of the present invention as a result of its use over time. As more and more publishers make their advertising spaces available, and more and more advertisers bid on the spaces, a natural ranking of the most popular advertising spaces will take place. The intermediary keeps track of the number and amount of bids made for particular advertising space or market sectors (e.g. keywords), and continuously organizes and updates the lists of available ad space according to this data. When an advertiser searches through the intermediary's web site for advertising platforms in particular market sectors, the more popular publishers will come out first, followed in order by lesser ranked publishers based on the same factor.

Because the present methods can be used as a self-serve tool and business owners can easily use it without having to hire an ad agency, the invention gives business owners the power, freedom and flexibility to choose what businesses (publishers) they should place their bids on, and how many their bids should be for each publisher. Based on historical data, in the intermediary's search engine, when a potential publisher enters a term identifying particular goods or services, it can learn the names of all the businesses that sell or provide the specific goods or services entered.

Moreover, when a potential advertiser searches the web site of the intermediary, the search results are organized according to the number of advertisers that had placed bids on the publisher, as well as by the amount of the bids that were placed. The larger the number of bidders and/or the higher the amounts of the bids for a given publisher, the higher the publisher will be ranked in the search results. This feature saves considerable time and energy, and provides valuable information to those who access and search the intermediary, because those who care the most—the business experts in the relevant market—are the ones placing the bids which determine the ranking.

In addition, as the number of advertisers working through the intermediary increases, an ever increasing list of products and services will develop. Eventually, this list may be accessed by potential purchasers who want to identify products and/or services that have an established track record through the intermediary. Thus the intermediary itself may act as a smart clearing house for potential purchasers of products and services.

Accordingly, the present invention creates a self serve market place for selling and buying advertising without fear of rejection regardless of the price the advertiser is willing to pay. In addition to providing an advertising market place for the placing of advertising, the present invention also serves as a sales force team for advertisers, and as an accurate search engine for information regarding the popularity of advertising space and advertised products and services.

The disclosed embodiments may be used with all different technologies including Internet, wireless, and other telecommunication, satellite, nano, or other technologies that have been or are yet to be created. The technology is not limited to any mentioned or non-mentioned technologies that may be invented in the future.

It is to be appreciated that the methods described herein may be applied to numerous different advertising and published media including without limitation cellular telephones, video billboards, television, radio, periodicals, magazines, newspapers and the like, as well as with telecommunication, satellite, nano or other technologies that have been or are yet to be created. It is also to be appreciated that different combinations of the several methods described herein may be used in combination with each other.

It will be apparent to those skilled in the art that various modifications and variations can be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A method for valuing and placing advertisements on an advertising space for display, the method comprising:
receiving a bid from an advertiser at an intermediary, wherein the bid corresponds to an advertisement for placement on the advertising space;
placing the bid in a pool having a plurality of bids;
performing a distribution calculation based on the plurality of bids within the pool; and
allocating an advertisement for each bid received to the advertising space for display according to the calculation.

2. The method of claim 1, further comprising providing the advertisement for display on the advertising space to the intermediary.

3. The method of claim 1, further comprising displaying an advertisement on the advertising space for a segment corresponding to the bid.

4. The method of claim 3, further comprising displaying another advertisement on the advertising space for another segment corresponding to another bid.

5. The method of claim 1, further comprising ranking each bid within the pool.

6. The method of claim 1, further comprising placing the bid with the intermediary, wherein the bid meets a specified criterion.

7. The method of claim 1, further comprising paying a publisher for use of the advertising space by the intermediary.

8. The method of claim 1, further comprising receiving a payment from the advertiser at the intermediary, wherein the payment is based on the bid.

9. A method for allocating advertisements to an advertising space for display to consumers, the method comprising:
providing a code or information by a publisher to an intermediary, wherein the code or information accesses a platform to display advertisements on the advertising space;
providing an advertisement to the intermediary from an advertiser;
receiving a bid from the advertiser to display the advertisement on the advertising space at the intermediary; and
allocating a segment to display the advertisement on the advertising space based on the bid, wherein the allocated segment is determined according to a distribution calculation.

10. The method of claim 9, further comprising ranking the bid within a pool of bids, wherein a higher bid amount results in a higher allocated segment to display the advertisement on the advertising space.

11. The method of claim 10, wherein the pool of bids includes bids from a plurality of advertisers to advertise on the advertising space.

12. A method for valuing and placing advertisements on an advertising space for display, the method comprising:
receiving a plurality of bids from advertisers at an intermediary, wherein the bids correspond to advertisements for placement on the advertising space;
ranking the plurality of bids;
performing a distribution calculation based on the plurality of bids within the pool; and
allocating a segment to display advertising on the advertising space for each bid received according to the calculation, wherein a higher bid amount receives a higher ranked segment of the allocated segments.

13. The method of claim 13, wherein the higher ranked segment corresponds to a higher percentage of access to the advertising space.

14. The method of claim 13, further comprising registering a publisher that provides the advertising space.
